(19) United States
(12) Patent Application Publication
(10) Pub. No.: US 2013/0106916 A1
(43) Pub. Date: May 2, 2013

(54) DRAG AND DROP HUMAN AUTHENTICATION

(71) Applicant: Qing Kevin Guo, Shanghai (CN)

(72) Inventor: Qing Kevin Guo, Shanghai (CN)

(21) Appl. No.: 13/649,316

(22) Filed: Oct. 11, 2012

Related U.S. Application Data
(60) Provisional application No. 61/552,259, filed on Oct. 27, 2011.

(51) Int. Cl. G09G 5/00

(52) U.S. Cl. 345/672

(57) ABSTRACT

A new human authentication test requires the user to move an image to a specified location on the display. In one embodiment, the user is presented with a display having one or more images and instructions (plain text or distorted) to move a specific image to a specific location on the display. The user then moves the image, which can be text, distorted text, a symbol, an icon, or any image, to the specified location. The system then checks where the image was moved. If the location is the one expected, the system can authenticate the response as coming from a human, as opposed to a machine or program.

### RELATED APPLICATION

This application claims priority to U.S. Provisional Application Ser. No. 61/552,259, filed Oct. 27, 2011 which is incorporated by reference in their entirely.

### BACKGROUND

1. Technical Field

The present application generally relates to authentication and more particularly to human authentication.

2. Related Art

A CAPTCHA is commonly used to ensure that a response is generated by a person instead of a machine or software program. Typically, a distorted text is presented on a display, and the user is requested to enter the text into a field. If the entered text is what is expected, indicating that a human has responded, the system proceeds with the communication. While CAPTCHAs are generally effective, they can be difficult and frustrating for the user because a text may be so distorted that the user cannot enter the correct text, resulting in the need to receive a new CAPTCHA and again enter text. This problem may be even more prevalent with mobile devices, such as smart phones, because the distorted text may be even harder to recognize on a smaller display, and the keypad/keyboard is smaller, making it more difficult to type in the text.

### BRIEF DESCRIPTION OF THE DRAWINGS

FIG. 1 is a flowchart showing a process a service provider makes in conducting a drag and drop authentication according to one embodiment;

FIG. 2 is a flowchart showing a process a user makes in authenticating through a drag and drop process according to one embodiment;

FIGS. 3A and 3B are exemplary screen shots a user may see for performing a drag and drop authentication according to one embodiment;

FIG. 4 is a sample screen shot of a user instruction display for performing a drag and drop authentication according to another embodiment;

FIG. 5 is block diagram of a networked system suitable for implementing the process described herein according to an embodiment; and

FIG. 6 is a block diagram of a computer system suitable for implementing one or more components in FIG. 5 according to one embodiment.

### DETAILED DESCRIPTION

In one embodiment, a new human authentication test requires the user to drag and drop an image to a specified location on the display. In one embodiment, the user is presented with a display having one or more images and instructions to drag and drop a specific image to a specific location on the display, such as the green box, the oval box, the second box on the right, the third box down, etc. The user then drags the image, which can be text, distorted text, a symbol, an icon, or any image, to the specified location. The system then checks where the image was dropped. If the location is the one expected, the system can authenticate the response as coming from a human, as opposed to a machine or program.

Such an authentication test is easier for the user than traditional CAPTCHAs, especially on mobile devices or other devices with smaller screens and/or smaller keyboards.

In one embodiment, a user is asked to drag and drop an image to a specific location on a display in order to continue communication with another entity. The entity can be an online merchant, an online financial institution, an online retailer, an online content provider, or any online entity or system that desires to authenticate a communication as coming from a person instead of a machine or computer program. When the user accesses a site, such as through a browser or mobile App, the user is requested to drag and drop (or otherwise move) a specific image to a specific location on the display of the user device. The user device may be a smart phone, a tablet, a PC, or other computing device. If the user moves the correct image to the correct location, the user can be authenticated as a human, and the entity may proceed with communication through the user device.

In one embodiment, the user is shown one image and asked to move the image to a certain location on the display. The image can be text, distorted text, a photo, an icon, a symbol, or other type of image. With the image, the user is also shown instructions of where to place the image. For example, the instructions may be in text or distorted text requesting the user drag and drop (or otherwise move) the image to the green box (from a plurality of boxes, only one of them being green), to the oval box (from a plurality of boxes, only one of them being oval), to the third box from the right (from a plurality of boxes arranged horizontally), to the second box from the bottom (from a plurality of boxes arranged vertically), to the center of the display, to the right corner of the display, etc. The user can then move the image to the specified location. For example, the user can place a finger on the image and move the finger to the specified location and then remove the finger. With a mouse or trackball, the user can move a pointer to the image, click on or otherwise select the image, move the pointer to the specified location, and unclick or click again.

The location is then communicated to the entity through the user device, which the entity or system processes to determine if the received location is the correct or specified location. If so, the user can be authenticated as human. If not, the user may be asked to drag and drop the image to a new specified location. The user may be given a specified number of opportunities to correctly place the image.

In another embodiment, the user is shown a plurality of images and asked to move a specific one of the images to a certain location on the display. The image and location can be as described above. The user may be presented with instructions for which one of the images to select. For example, the instructions may be to move the second image from the right (from a plurality of images arranged horizontally), the green image (from a plurality of different colored images, only one of them being green), the check mark (from a plurality of different symbols/characters, only one of them being a check mark), the cat (from a plurality of different animals, only one of them being a cat), etc.

The test can be different each time the user attempts a new communication with the entity. For example, only a single image may be shown in one test, and a plurality of images shown in another test. Different tests may result in different images and/or different specified locations.

In one embodiment, the drag and drop test may be the only test. In another embodiment, the drag and drop test may be another option in addition to a standard CAPTCHA test, where the user can choose to perform either test.

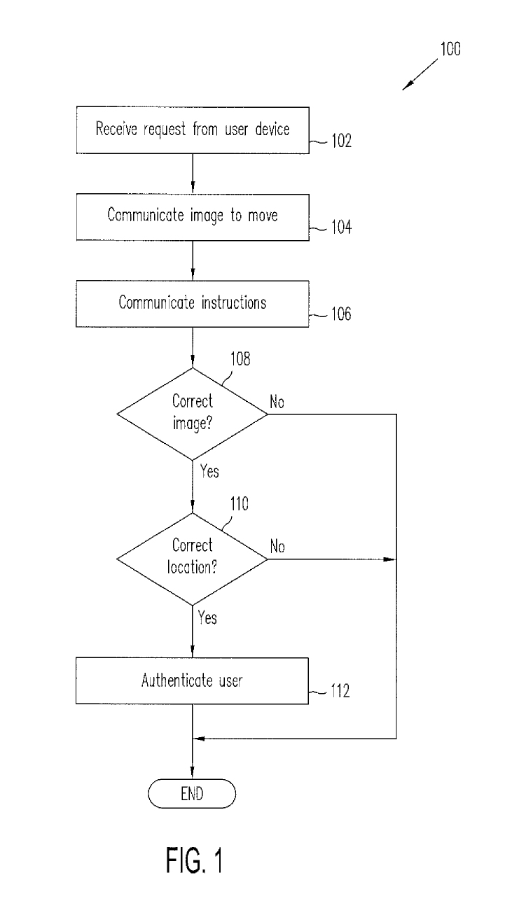

FIG. 1 is a flowchart 100 showing a process a service provider makes in conducting a drag and drop authentication according to one embodiment. At step 102, a service provider receives a request from a user through a user device to access information, receive information, or otherwise engage in information communication. The request may be a user accessing a mobile app, a URL, a link or a button of the service provider. The request may be to receive information from the service provider and/or engage in a transaction with the service provider. In various situations, before granting the user access to information, the service provider may first determine whether the request is from a human or a machine/software.

At step 104, the service provider, such as through a server, communicates an image to move by the user. The image may be displayed on the user device. In one embodiment, the image is a single image, such as, but not limited to, text, distorted text, a symbol, an icon, a photo, a picture, or one or more numbers, letters, and/or characters. In another embodiment, the image is a plurality of such images. The images may all be the same color or two or more images may be shown in different colors.

The same or different display may show the user instructions for the test or human authentication. The instructions, such as sent by a service provider server, may be how the user is to move an image to a location on the device display. In different embodiments, the instructions are in plain text, in distorted text, voice, or a combination thereof. A distorted or partial distorted text may provide additional security, as it may be harder for non-human to recognize and understand the instructions, but a cost may be that it is harder for a human user as well, such as with a small screen, bad eyesight, and/or extremely distorted characters.

The instructions may request the user to the displayed image to a specific location on the display. Exemplary instructions include, but are not limited to, move the image to a spatial location, such as the upper right corner, the lower left corner, the center, etc. Instructions may also include moving the image to a visual marker based on color, shape, size, image type, spatial location and/or other visual indicators. Examples include moving the image to the largest circle, the red square, the oval, the dog, the letter Q, the second square on the right, the moon, the upper case letter, the smallest number, etc. The visual marker can be virtually anything that the user can see on the display and may require the user to analyze/process the instructions.

In embodiments where multiple images are shown, instructions may include which of the images to move. The instructions may be similar to those described above, i.e., moving an image at a specific location or moving an image that meets the parameters or description contained in the instructions. For example, the instructions may instruct the user to move the image at the center of the display where other images may be on the sides or corners, move the image at the upper left of the display where other images may be in the center or lower right of the display, move the red image where other images are of different colors, move the biggest image where other images are noticeably smaller in size, move the brightest image where other images are noticeably dimmer, move the number where the other images are letters or symbols, move the dog where other images are cats, birds, cars, or other non-dog images, move the letter where other images are words, etc.

Once the image(s) and instructions are presented or communicated to the user on the user device, the user follows the instructions and moves an image to a specific location on the user device. This can be done in any suitable way and can depend on the device. For example, with a touch-screen display, the user may use a finger to move the image. With a PC, the user may use a mouse or trackball.

The image movement is then communicated to the service provider. For example, the service provider may know where each image is located initially and where an image ends up, based on spatial location. The image movement is then compared to determine whether the movement is correct.

At step 108, a first determination is made whether the correct image has been moved. This step may be applicable only when a plurality of images is presented to the user. For example, if the user was asked to move the red ball (which was located initially at a specific spatial location determinable by the service provider) and a blue ball (located initially at a different spatial location) is moved, the service provider may determine that the incorrect image was moved based on what location the image was moved from. In that case, the service provider may end the authentication process. Note that even though the process(es) described herein may not result in authentication, the user may still be authenticated through other means, such as a traditional CAPTCHA in which the user simply enters a distorted text into a box.

If the correct image was moved by the user (e.g., moving the correctly instructed image or moving the single image provided), a determination is made, at step 110, whether the image was moved to the expected location. Again, this determination can be made from determining where the image is moved on the device. For example, if the user was asked to move the image to the green box, the system knows where the green box was displayed on the device and determines whether the image was moved to the location corresponding to the green box location. So, if the green box is associated with a location on the upper right side of the display, and the image was moved to a location on the bottom right side (where a red box may be associated), the system may determine that the image was moved to an incorrect location. The authentication may end, or the user may enter a traditional CAPTCHA as discussed previously.

If the correct image was selected and the image was moved to the correct location, the user may be authenticated, at step 112, as a human. The system or service provider may then engage in substantive communication or information transfer with the user.

Note that one or more the steps described herein may be omitted, combined, or performed in a different sequence as desired and suitable.

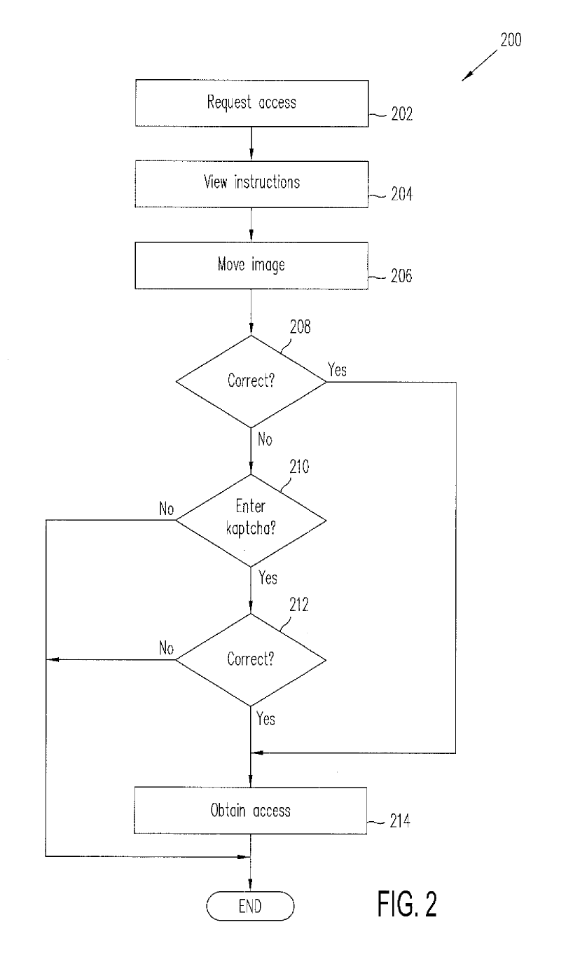

FIG. 2 is a flowchart 200 showing a process a user makes in authenticating through a drag and drop process according to one embodiment. At step 202, the user requests access to information from a service provider. For example, the user may be on a mobile app or website of the service provider and request specific information from the service provider, such as by selecting a link or button or entering a request that is submitted to the service provider. If the service provider will only communicate such information to humans (as opposed to machines or software), the service provider traditionally sends a distorted text or CAPTCHA test, in which the user is required to correctly enter the text in order to be authenticated.

However, with embodiments described herein, the user is presented with instructions, at step 204, that the user views on a user device, such as a PC, smart phone, or computing tablet. The instructions, as described above, may include distorted or undistorted instructions for the user to select the shown image or one of the shown images and to drag or otherwise place that image to a specific location on the display.

The user then, at step 206, moves an image to a specific location on the display, such as using a finger, mouse, or other means to select, drag, and drop. The initial location of the image, which also allows the service provider to determine which image the user has selected, and the end location of the image are communicated to the service provider.

At step 208, a determination is made whether the correct image was moved and whether the image was moved to a correct location. Again, this can be determined based on spatial location of the image moved and where the image is placed or dropped. If the correct image is moved to the correct or expected location, the user is authenticated and is given access to information, at step 214.

However, if the user moved the wrong image or moved an image to an incorrect location, the user may be given the option, at step 210, of using a traditional CAPTCHA test to be authenticated. If the option is not given or the user does not enter any text, the authentication process may end with the user not being given access to information from the service provider.

However, if the user is provided an option to enter a CAPTCHA text, the user is presented with a distorted text and asked to enter the text into a field on the display. The user then enters text, such as through a device keypad, into the requested field.

A determination is then made, at step 212, whether the entered text is correct. If not, the authentication process may end. If the entered text is correct, the user may be given access, at step 214, to information from the service provider.

Thus, a user may be easily authenticated as human, even on a smaller user device with smaller keypads, using a drag and drop authentication.

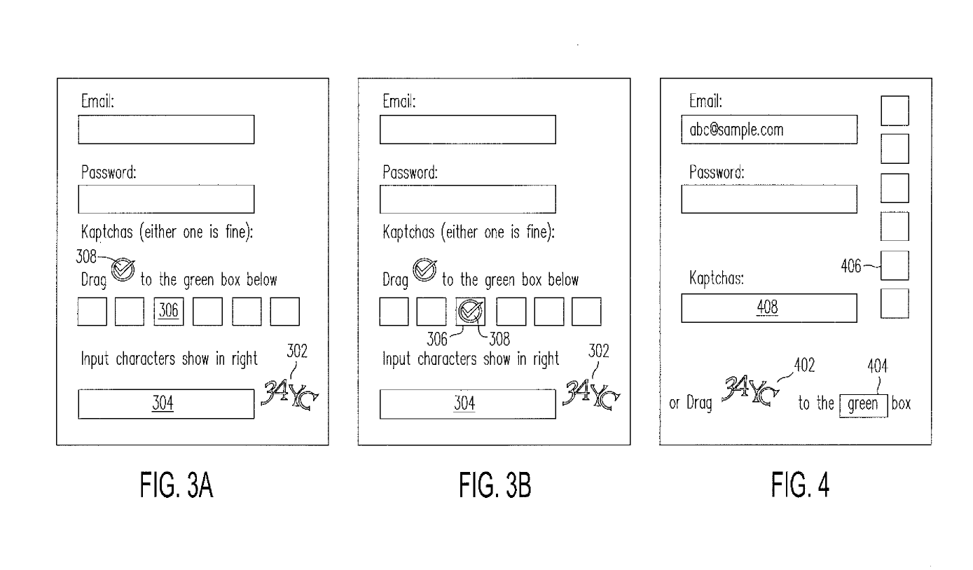

FIGS. 3A and 3B are exemplary screen shots a user may see for performing a drag and drop authentication according to one embodiment. FIG. 3A shows a display a user may see on a mobile phone, computing tablet, or PC after the user has requested information from a service provider. A distorted text 302 is shown, along with a box or field 304 to enter distorted text 302. This is a conventional CAPTCHA, which is provided to the user as an option for authentication in the event the user does not want to use or cannot be authenticated through a drag and drop authentication. Instructions, in plain text, instruct to the user to drag an image 308 (a check mark) to a green box 306. The display shows six boxes, with the green box 306 being the third box from the left. Thus, the green box is associated with a specific location on the display. The other boxes may be the same non-green color or be one or more different non-green colors.

In FIG. 3B, the user has dragged image 308 into the second box from the left (i.e., green box 306). The user may have placed a finger on image 308 and moved the finger to green box 306, placed a mouse over image 308, clicked on the image, and moved the mouse to green box 306, or other suitable means for moving the image. If the image is moved the correct location, text 302 and/or field 304 may be disabled.

FIG. 4 is a sample screen shot of a user instruction display for performing a drag and drop authentication according to another embodiment. Here, a distorted image 402 is shown as the image to be moved, where distorted image 402 can also be entered into a field or box 408. Instructions, in plain text, request the user to move distorted image 402 to a green box 404, where a green box is actually shown in the instructions. A set of vertical boxes are shown on the right side of the display, with the green box at location 406. Thus, user can drag image 402 to the second box from the bottom to be authenticated by the system.

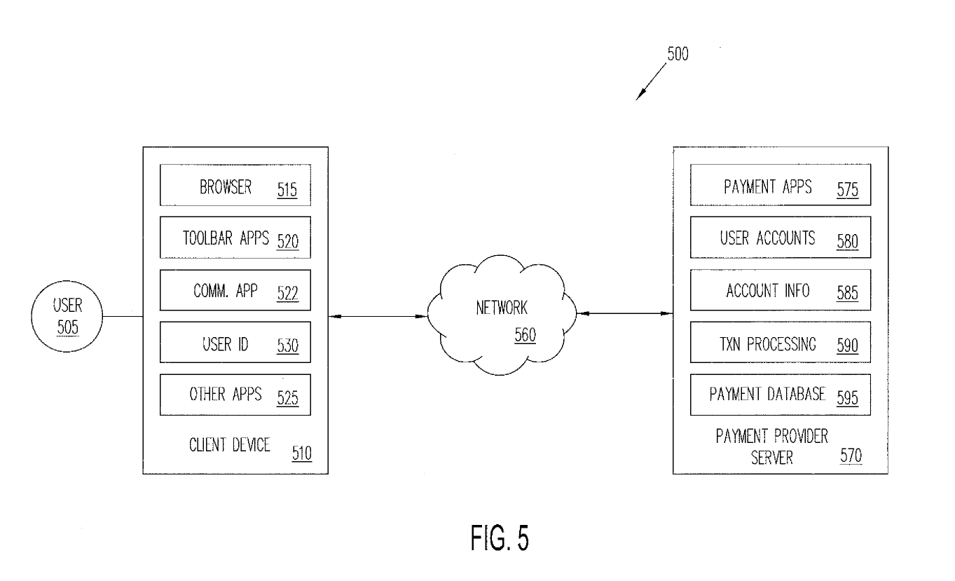

FIG. 5 is a block diagram of a networked system 500 configured to authenticate a user as human, such as described above, in accordance with an embodiment of the invention. System 500 includes a user device 510 and a payment provider server 570 in communication over a network 560. Payment provider server 570 may be maintained by a payment provider, such as PayPal, Inc. of San Jose, Calif.

Although a payment provider device is shown, the server may be managed or controlled any suitable service provider that requires authentication as a human before communicating information. A user 505 utilizes user device 510 to view account information and perform transaction using payment provider server 570. Note that transaction, as used herein, refers to any suitable action performed using the user device, including payments, transfer of information, display of information, etc. Although only one server is shown, a plurality of servers may be utilized. Exemplary servers may include, for example, stand-alone and enterprise-class servers operating a server OS such as a MICROSOFT® OS, a UNIX® OS, a LINUX® OS, or other suitable server-based OS. One or more servers may be operated and/or maintained by the same or different entities.

User device 510 and payment provider server 570 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

Network 560 may be implemented as a single network or a combination of multiple networks. For example, in various embodiments, network 560 may include the Internet or one or more intranets, landline networks, wireless networks, and/or other appropriate types of networks.

User device 510 may be implemented using any appropriate hardware and software configured for wired and/or wireless communication over network 560. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 510 may include one or more browser applications 515 which may be used, for example, to provide a convenient interface to permit user 505 to browse information available over network 560. For example, in one embodiment, browser application 515 may be implemented as a web browser configured to view information available over the Internet, such as authentication tests and information from the payment provider. User device 510 may also include one or more toolbar applications 520 which may be used, for example, to provide client-side processing for performing desired tasks in response to operations selected by user 505. In one embodiment, toolbar application 520 may display a user interface in connection with browser application 515 as further described herein.

User device 510 may further include other applications 525 as may be desired in particular embodiments to provide desired features to user device 510. For example, other applications 525 may include security applications for implementing client-side security features, programmatic client applications for interfacing with appropriate application programming interfaces (APIs) over network 560, or other types of applications. Applications 525 may also include email, texting, voice and IM applications that allow user 505 to send and receive emails, calls, and texts through network 560, as well as applications that enable the user to communicate and transfer information through the payment provider as discussed above. User device 510 includes one or more user identifiers 530 which may be implemented, for example, as operating system registry entries, cookies associated with browser application 515, identifiers associated with hardware of user device 510, or other appropriate identifiers, such as used for payment/user/device authentication. In one embodiment, user identifier 530 may be used by a payment service provider to associate user 505 with a particular account maintained by the payment provider. A communications application 522, with associated interfaces, enables user device 510 to communicate within system 500.

Payment provider server 570 may be maintained, for example, by an online payment service provider which may provide information to and receive information from user 505, such as for making payments. In this regard, payment provider server 570 includes one or more payment applications 575 which may be configured to interact with user device 510 over network 560 to facilitate sending payments from user 505 of user device 510.

Payment provider server 570 also maintains a plurality of user accounts 580, each of which may include account information 585 associated with consumers, merchants, and funding sources, such as credit card companies. For example, account information 585 may include private financial information of users of devices such as account numbers, passwords, device identifiers, user names, phone numbers, credit card information, bank information, identification cards, photos, or other information which may be used to facilitate transactions by user 505.

A transaction processing application 590, which may be part of payment application 575 or separate, may be configured to receive information from a user device for processing and storage in a payment database 595. Transaction processing application 590 may include one or more applications to process information from user 505 for processing a payment using various selected funding instruments or cards. As such, transaction processing application 590 may store details of an order from individual users, including funding source(s) used, credit options available, etc. Payment application 575 may be further configured to determine the existence of and to manage accounts for user 505, as well as create new accounts if necessary, such as the set up and management payments by the user.

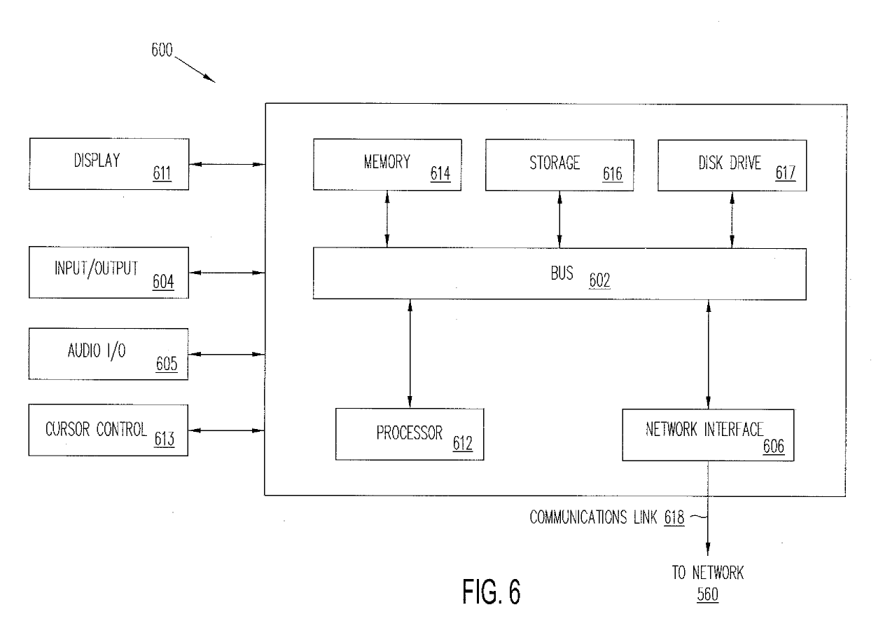

FIG. 6 is a block diagram of a computer system 600 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The payment provider may utilize a network computing device (e.g., a network server) capable of communicating with the network. It should be appreciated that each of the devices utilized by users and payment providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, moving images from on location of a display to another location, etc., and sends a corresponding signal to bus 602. I/O component 604 may include a camera or other image capture device for capturing an image of a user card. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another user device, a merchant server, or a payment provider server via network 360. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via a communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing a location of an image to be moved by a user and a location the image is expected to be moved to on a user device display; and
one or more hardware processors in communication with the non-transitory memory and configured for:
receiving a request from a user to access information;
displaying, on a user device, at least one image for the user to move;
identifying an image for the user to move;
communicating, to the user device, a first location to move the image;
receiving a second location where the user moved the image;
determining whether the second location matches the first location; and
authenticating the user as a human if, at least, the second location matches the first location.

2. The system of claim 1, wherein the image comprises a text, a symbol, a photo, a character, a number, or a combination thereof.

3. The system of claim 1, wherein the image is distorted.

4. The system of claim 1, wherein a plurality of images are displayed on the user device.

5. The system of claim 4, wherein the identifying comprises identifying one of the plurality of images to move.

6. The system of claim 1, wherein the communicating comprises displaying instructions in distorted text.

7. The system of claim 1, wherein the image is moved to the first location through a drag and drop process.

8. A method comprising:
receiving, electronically from a user device, a request from a user to access information;
displaying, on the user device, at least one image for the user to move;
identifying an image for the user to move;
communicating, to the user device, a first location to move the image;
receiving a second location where the user moved the image;
determining whether the second location matches the first location; and
authenticating the user as a human if, at least, the second location matches the first location.

9. The method of claim 8, wherein the image comprises a text, a symbol, a photo, a character, a number, or a combination thereof.

10. The method of claim 8, wherein the image is distorted.

11. The method of claim 8, wherein a plurality of images are displayed on the user device.

12. The method of claim 11, wherein the identifying comprises identifying one of the plurality of images to move.

13. The method of claim 8, wherein the communicating comprises displaying instructions in distorted text.

14. The method of claim 8, wherein the image is moved to the first location through a drag and drop process.

15. A non-transitory computer readable medium comprising a plurality of machine-readable instructions which when executed by one or more processors of a server are adapted to cause the server to perform a method comprising:
receiving a request from a user to access information;
displaying, on a user device, at least one image for the user to move;
identifying an image for the user to move;
communicating, to the user device, a first location to move the image;
receiving a second location where the user moved the image;
determining whether the second location matches the first location; and
authenticating the user as a human if, at least, the second location matches the first location.

16. The non-transitory computer readable medium of claim 15, wherein the image comprises a text, a symbol, a photo, a character, a number, or a combination thereof.

17. The non-transitory computer readable medium of claim 15, wherein the image is distorted.

18. The non-transitory computer readable medium of claim 15, wherein a plurality of images are displayed on the user device.

19. The non-transitory computer readable medium of claim 18, wherein the identifying comprises identifying one of the plurality of images to move.

20. The non-transitory computer readable medium of claim 15, wherein the communicating comprises displaying instructions in distorted text.
